(19) United States
(12) Patent Application Publication
(10) Pub. No.: US 2013/0206699 A1
(43) Pub. Date: Aug. 15, 2013

(54) Method for the Open-Loop Control and/or Closed-Loop Control of Filter Systems with a Media Filter

(71) Applicant: KRONES AG, (US)

(72) Inventors: Dirk Scheu, Bopfingen (DE); Jörg Zacharias, Koefering (DE)

(73) Assignee: KRONES AG, Neutraubling (DE)

(21) Appl. No.: 13/751,607

(22) Filed: Jan. 28, 2013

(30) Foreign Application Priority Data
Feb. 13, 2012 (DE) DE102012202112.4

(51) Int. Cl. B01D 24/48

(52) U.S. Cl. CPC B01D 24/48
USPC 210/660; 210/807; 210/739

(57) ABSTRACT

A method for the open-loop control and/or closed-loop control of a filter system for the filtration of an untreated fluid with a media filter, particularly with a gravel bed filter, multilayer filter or activated charcoal filter, whereby the open-loop control and/or closed-loop control takes place on the basis of the fuzzy logic and/or artificial neural networks.

### CROSS-REFERENCE TO RELATED APPLICATION

The present application claims the benefit of priority of German Application No. 10 2012 202 112.4, filed Feb. 13, 2012. The entire text of the priority application is incorporated herein by reference in its entirety.

### FIELD OF THE DISCLOSURE

The present disclosure relates to a method for the open-loop control and/or closed-loop control of a filter system for the filtration of a fluid with a media filter.

### BACKGROUND

Filter systems with media filters, meaning filters with a filter medium such as, e.g., gravel bed filters, activated charcoal filters and multilayer filters, are used in many ways in industry and environmental technology, but also in the private sector. Among the most common application areas are the preparation of process waters for industry and the production of drinking water. In the latter case, a significant role is played particularly by the filtering of iron and manganese compounds dissolved in the untreated water after the addition of oxygen and conversion into insoluble hydrated oxides. It is also possible to remove unwanted components such as arsenic, uranium or organic materials. Media filters are additionally used, after the addition of flocculants, for the removal of turbidities as well as, using alkaline filter media, for the deacidification of untreated water. Further applications are found in filtering algae and organic substances in swimming pools, stagnant bodies of water and fountains, as well as in the treatment of groundwater and wastewater. Filter systems with media filters are additionally frequently used for preparing microfiltration or ultrafiltration.

Filter systems with media filters are thereby normally operated according to a very rigid sequence, which can be adjusted, typically by experts, within narrow limits by means of a few parameters. For the open-loop control and/or closed-loop control of the filter system, however, the ordinary system user is generally tied to the programs that have been stipulated before the commissioning of the system and that frequently are pre-programed. In consequence, an adjustment of the operating method of the filter system to changing process conditions, such as, e.g., changing quality of the untreated water, changing temperature and changing loading cycles, as well as a change in the filter, is either not possible or requires the effort of a trained expert.

During the production process, the substances to be filtered out accumulate in the filter bed of the media filter, which causes an increase in the filter resistance and ultimately a reduction in the efficiency of the filtration process. Due to this so-called filter fouling, routine cleaning of media filters by backwashing is necessary. In the state of the art, the backwashing that is to be carried out is likewise coupled to a rigid program sequence which controls the individual steps of the backwashing according to fixed values and times.

Due to the program sequences permanently stipulated during the commissioning of the system, optimization of the operation of the system, particularly the filter cleaning by means of backwashing, is ultimately made more difficult or impossible. This jeopardizes particularly the production reliability and product reliability of the system. It is furthermore not possible to use resources such as backwashing water, air, and energy efficiently.

### DESCRIPTION OF THE INVENTION

One aspect of the present disclosure is therefore to provide a method for the intelligent open-loop control and/or closed-loop control of filter systems for the filtration of an untreated fluid with a media filter that overcomes the disadvantages mentioned above. In particular, optimization of the filter cleaning by means of backwashing with regard to production reliability and efficient resource utilization should be made possible even without extensive expert knowledge. The method should moreover be capable of reacting to changing process conditions in a suitable and flexible manner.

The above mentioned aspect is solved by means of a method for the open-loop control and/or closed-loop control of a filter system for the filtration of an untreated fluid with a media filter, whereby the open-loop control and/or closed-loop control takes place on the basis of a fuzzy logic and/or artificial neural networks.

In particular, the untreated fluid to be filtered can be a liquid, for example, water, particularly fresh water. Alternatively, the method according to the disclosure can be used for the filtration of waste water in water treatment technology, of process waters of either an industrial nature or in environmental or swimming pool technology, of recycling water and of ground water. Also conceivable is the use of the method according to the disclosure for the separation of iron and manganese compounds, for the removal of unwanted components such as uranium and arsenic by means of adsorption, for the removal of turbidities, for deacidification with the help of alkaline filter media, and as preparation for microfiltration or ultrafiltration.

In filtration with a media filter, the size of the particles or macromolecules to be separated out is typically in the range of greater than 1 μm (1 μm=10⁻⁶ m), particularly in the range from >1 μm to 1000 μm. The particles or macromolecules to be separated out can be water-soluble and water-insoluble salts, iron and manganese compounds, bacteria, algae, yeasts, pollen, sand or organic substances.

Filtration with a media filter is thereby generally carried out as dead-end filtration. In dead-end filtration, the fluid that is to be filtered is pumped against the filter with the lowest possible pressure. The filtrate (also permeate) penetrates through the filter while the separated particles or macromolecules remain as a concentrate (also retentate) in the inlet area of the filter, or consequently in front of the filter as seen in the direction of flow.

A media filter is a filter with a filter medium. The filter medium can be fill comprising granular filter materials, but also felt, tissue, paper and porous solid bodies. Filter materials for fill can thereby particularly be gravel with the widest range of grits, sand, activated charcoal, neutralisation media, anthracite, hydro-anthracite, limestone or alkaline materials. A fill of a filter medium is also called the filter bed. A gravel bed filter is consequently a media filter with one or more fills or layers of gravel as the filter bed.

A media filter can be formed as an open filter, whereby just the difference in height between the untreated fluid level and the clean fluid area generates the pressure required for the filtration. Alternatively, a media filter can be formed as a pressure filter or spatial filter in which the filter media are poured down within a closed container as the filter bed and pumps generate the required operating pressure. In a spatial filter, the flow through the filter is generally from the bottom towards the top. A media filter can moreover be formed as a surface filter or as a depth filter. In a surface filter, the separated particles or macromolecules are deposited on the surface in the form of a so-called filter cake, while the deposit is internal in a depth filter. In both cases, the filter resistance increases during the course of the filtration, so that it is necessary for the media filter to be cleaned, e.g., by means of backwashing, at regular intervals (see discussion farther below).

A media filter can moreover be formed with a poured layer or also as a multilayer filter with a plurality of layers consisting of different filter materials. The grit of the individual layers thereby generally increases continuously in or opposite to the direction of flow. A multilayer filter is also often called a multimedia filter.

In the fuzzy logic, complex problems can be described in a simple manner by using fuzzy rules. For each concrete input variable, the membership function of the fuzzy set of a linguistic term is used to determine the grade of membership to the corresponding linguistic term.

According to a further development, the method according to the disclosure comprises the capture of at least a first and a second process variable of the filter system (as input variables), the determination of a first grade of membership of the first process variable to a first linguistic term on the basis of a first predetermined membership function, the determination of a second grade of membership of the second process variable to a second linguistic term on the basis of a second predetermined membership function, the logical combination of the first and second linguistic terms according to at least a first predetermined rule for the determination of a first resulting membership function of the action of the first predetermined rule, the determination of an overall membership function on the basis of the first resulting membership function of the action of the at least first predetermined rule, the obtaining of an output value from the overall membership function, as well as the open-loop control and/or closed-loop control of the filter system depending on the output value.

In particular, a cleaning process of the media filter can thereby be open-loop controlled or closed-loop controlled depending on the output value.

The use of the fuzzy logic for the open-loop control and/or closed-loop control of the filter system thereby makes it possible to influence the process control by means of specifying simple and intuitive linguistic rules and terms, and consequently it expands the options the system user has to influence the optimal operation of the filter system.

In particular, the process variables can be captured by means of measurement, particularly by sensors, particularly in the area of the filter.

Additionally, value ranges can be defined for the captured process variables, whereby these value ranges can be partitioned by means of the definition of suitable fuzzy sets. Appropriate linguistic terms thereby are associated with the fuzzy sets. The partitions and particularly the membership functions of the fuzzy sets here can be parameterized by suitable parameters, whereby in a continuation, the parameters can be adjusted by means of an artificial neural network. For example, triangular functions whose parameters are the width of the base and the position of the tip can be used as membership functions. Further examples for the membership functions of the fuzzy sets are trapezoidal and Gaussian functions, whereby Gaussian functions have the advantage of continuous differentiability and are consequently particularly suitable for use within optimization methods based on a gradient method, e.g., the steepest gradient method. If desired, a different membership function can be defined for each fuzzy set.

In the fuzzy theory, a rule, or more precisely a linguistic rule, comprises a number of premises (also called antecedents) in the form of a membership of a number of input variables to a number of linguistic terms, which are combined with one another by means of a logical combination (the result being called the precondition), and an action (also called consequent or consequence) in the form of a membership function of an output value to a linguistic term (generally called the “if-then” form).

In the method according to the disclosure, each rule can be stipulated by an expert or learned by an automated method. The automated method can, in particular, be an artificial neural network. Such an artificial neural network can thereby learn or adjust rules by means of observation, i.e., the logging and evaluation of suitable process data of the filter system, whereby the observation can be done by an expert particularly during the process operation.

A predetermined or learned rule can furthermore be adjusted by means of optimization steps. An optimization step can thereby comprise the adjustment of the abovementioned parameters to a fuzzy set belonging to a linguistic term used in a rule or a prioritization or elimination of the rule. A prioritization or elimination can thereby take place particularly by setting or adjusting weightings of a rule in the determination, as given by the disclosure, of an overall membership function on the basis of the resulting membership function of the action of the rule.

In the shifting of a fuzzy set by the adjustment of its parameters in an optimization step, particularly the membership of the fuzzy set to a previously defined value range of the corresponding process variable can be introduced as a boundary condition.

Two or more linguistic terms can be combined logically by means of the customary logic operators, particularly by means of AND, OR and XOR. Binary or ternary operators, or also operators with more than three operands, can thereby be used. Furthermore, the unary operation of negation can be applied to any linguistic term.

In the logical AND combination of two or more linguistic terms of the premises of a rule, the grade of the precondition of the rule can be formed particularly by the minimum of the grades of membership of the input variables to their corresponding linguistic terms. In the logical OR combination of two or more linguistic terms of the premises, the grade of the precondition can be formed particularly by the maximum of the grades of membership of the input variables to their corresponding linguistic terms. Alternatively, the logical AND and/or the logical OR combination can be carried out with the help of bounded sums.

The determination of a resulting membership function of an action of a rule takes place by means of mapping the grade of the precondition of the rule, meaning of the logically combined premises, of the “if” portion of the rule to the linguistic term of the action of the rule in the “then” portion of the rule. The mapping, which is called inference, can thereby take place by forming the minimum of the grade of the precondition and the membership function of the action, meaning by the graphic “truncation” of the membership function of the action to the level of the grade of the precondition. Alternatively to this, the mapping can take place by forming the product of the grade of the precondition and the membership function of the action.

A rule can comprise two or more premises, consequently two or more linguistic terms, as the precondition. Two or more linguistic terms can thereby be equal. Alternatively or additionally, two or more process variables that belong to the linguistic terms of the precondition can be equal.

The determination of an overall membership function on the basis of the first resulting membership function of the action of the at least first predetermined rule can take place particularly by equating the overall membership function to the resulting first membership function of the action. The resulting first membership function can thereby additionally be modified by weighting, particularly by multiplication with a weighting function across the range of an output variable of the action of the rule, and/or by truncation at predetermined boundaries of the value range of the output variable.

Obtaining an output value (defuzzification) from the overall membership function can take place particularly by the determination of the abscissa value of the center of gravity of the area lying under the overall membership function. Alternatively to this, according to the max criterion method, any value of the output variable for which the overall membership function has a maximum can be selected. Likewise, according to the mean-of-maximum method, the mean value across the set of values of the output variable for which the overall membership function takes on its (global) maximum can be selected as the value of the output variable. In the alternative design, particularly if the overall membership function is determined on the basis of a single resulting membership function of a single rule, the output value can be determined on the basis of the maximum of the resulting membership function or of the grade of the precondition of the single rule. In the abovementioned cases, an open-loop control and/or closed-loop control of the filter system can take place particularly by a comparison of the obtained output value with one or more predetermined boundary or threshold values. The predetermined boundary or threshold values can thereby be adjusted individually or together in one optimization step, whereby the optimization step can particularly be carried out by means of an artificial neural network.

According to a further development, the method for the open-loop control and/or closed-loop control of a filter system additionally comprises the capture of at least a third and a fourth process variable of the filter system, the determination of a third grade of membership of the third process variable to a third linguistic term on the basis of a third predetermined membership function, the determination of a fourth grade of membership of the fourth process variable to a fourth linguistic term on the basis of a fourth predetermined membership function and the logical combination of the third and fourth linguistic terms according to at least a second predetermined rule for the determination of a second resulting membership function of the action of the at least second predetermined rule, whereby the overall membership function is determined by the composition of at least the first resulting membership function of the action of the at least first predetermined rule and the second resulting membership function of the action of the at least second predetermined rule.

The above-described options can hereby likewise be applied to the evaluation of the second predetermined rule and possible further rules. In particular, the overall membership function can be determined by the composition of the resulting membership functions of the actions of more than two rules. The composition of the two or more resulting membership functions can take place particularly by the union of the corresponding fuzzy sets. The third and/or fourth process variable can be identical to the first and/or second process variable. Alternatively or additionally, the first predetermined rule can be identical to the second predetermined rule.

By combining a plurality of linguistic rules by means of composition, complicated correlations in the process control area can also be formulated easily. In particular, through composition, linguistic rules for the control of conflictive trends can be implemented, and consequently optimization of the process control is possible on the basis of the fuzzy logic.

The open-loop control and/or closed-loop control, as given by the disclosure, of a filter system can be carried out by means of a Mamdani controller or a Sugeno controller. In a Sugeno controller, the partitioning of the value range of the output variable can thereby be replaced with a mapping, particularly a linear mapping, of the value ranges of the captured process variables to the value range of the output variable.

According to the disclosure, the open-loop control and/or closed-loop control of the filter system can take place by means of the adjustment of one or more correcting variables on the basis of one or more obtained output values. Each output value can thereby be in particular the corresponding correcting variable.

According to a further development, the filter's cleaning process that is to be open-loop controlled or closed-loop controlled can comprise a backwashing of the filter, whereby the backwashing comprises at least three cleaning steps, including at least one pre-rinsing step and at least a first and a second main rinsing step. Alternatively or additionally to this, the cleaning process that is to be open-loop controlled or closed-loop controlled can comprise a cleaning-in-place of the filter, a combined backwashing and cleaning-in-place of the filter, a general cleaning of the filter, and one or more predetermined cleaning programs. A cleaning-in-place is generally a chemical cleaning of the filter. Alkaline cleaners and/or hydrogen peroxide can thereby be used as chemical cleaning agents. In a general cleaning of the filter, generally the complete stop of the filtering process is necessary. In particular, a general cleaning of a filter can include the replacement of the filter or individual filter components.

By means of intelligent and optimized control of the filter cleaning processes in a filter system, extended operation of the filter system and an improved service life of the filter are possible, and the proportion of resources used to the product are maintained in the optimal range. In particular, the stipulation of a few linguistic rules allows a flexible adjustment of the open-loop control and/or closed-loop control of the filter system to changing process conditions.

The captured process variables can be selected from the following group: temperature of the untreated fluid in a filter inlet, pressure of the untreated fluid in the filter inlet, pressure of a filtrate, differential pressure between the untreated fluid in the filter inlet and the filtrate, volume flow of the untreated fluid fed in the filter inlet, volume flow of the filtrate, flow rate of the untreated fluid fed in the filter inlet, flow rate of the filtrate, yield of the filter, operating time of the filter, service life of the filter, running time of the filter, turbidity of the untreated fluid in the filter inlet, turbidity of the filtrate, concentration gradient of a particle that is to be separated in the filter inlet, thickness of a cover layer on the filter, density of the cover layer on the filter, filtration resistance of the filter, filter throughput, cut-off limit of the filter, hardness grade of the untreated fluid in the filter inlet, hardness grade of the filtrate, electrical conductivity of the untreated fluid in the filter inlet, electrical conductivity of the filtrate, concentration of a salt in the untreated fluid in the filter inlet, concentration of the salt in the filtrate, concentration in the filter inlet of an ion that is critical for filter fouling, concentration in the filtrate of the ion that is critical for filter fouling, number of a filtration cycle, backwashing resistance of the filter, volume flow of a backwashing medium, flow rate of the backwashing medium in a backwashing inlet, turbidity of the backwashing medium in a backwashing outlet, differential pressure of the backwashing medium between the backwashing inlet and the backwashing outlet, duration of a backwashing step and lifetime of the filter, as well as their deviations from predetermined reference curves.

Each of the captured process variables can thereby be captured either as a value, as a temporal change of the value, as a temporal change in the temporal change of the value or as a temporal trend of the value. Individual process variables can likewise be captured at different points in time. In particular, one and the same process variable can be captured at different points in time. The temporal trend of a process variable can be captured at 3, 5, 10 or more points in time. Additionally, a captured process variable can be added up across a plurality of points in time.

The capture of suitable process variables makes possible precise and flexible open-loop control and/or closed-loop control of the filter system. In addition, the capture of temporal developments of process variables allows a projection of their development into the future and consequently better decision criteria.

The yield of a filter is the relationship of the volume flow of the filtrate to the volume flow of the fluid conveyed in the filter inlet. The service life of a filter is generally understood as the time for which this filter works until the next cleaning has to be carried out.

Due to the constant discharge of the filtrate (permeate), a growing boundary layer forms on the filter during the filtration process (cover layer or fouling). A concentration gradient of the separated particles or molecules thereby occurs in this boundary layer (concentration polarization). A corresponding gradient can also occur across the cross-section of the filter in that the substances that are to be separated collect in the filter bed. The filter thereby clogs, and the flow is reduced. The filtration resistance likewise increases as the thickness and/or density of the cover layer increases. The cut-off limit, i.e., the minimum size of the separated particles or molecules, can thereby likewise decrease. An ion critical for the filter fouling can be, for example, iron or manganese. A filtration cycle is generally delimited by two filter cleaning processes.

Backwashing of the media filter generally takes place in at least three cleaning steps. During the pre-rinsing step, a backwashing medium is fed through the filter in the direction opposite to the filtration direction at a stipulated speed and for a certain time. During the at least first and second main rinsing steps, one or more backwashing media are fed through the filter in the direction opposite to the filtration direction either separately, one after the other, or in combination. As a result, the filter medium or filter media are loosened and any existing pores of the filter medium are enlarged, so that the deposited, separated particles or macromolecules are carried out of the filter.

The resistance with which the filter opposes the backwashing thereby depends heavily on the cover layer that has formed on the filter, and on the particles or molecules that have penetrated into the filter and there become bound, particularly by means of adsorption processes. The backwashing medium can be, in particular, filtrate (permeate).

According to a further development, the rinsing during the first main rinsing step can take place with a first backwashing medium and the rinsing during the second main rinsing step can take place with a second backwashing medium that differs from the first backwashing medium. In particular, the first or second backwashing medium thereby can be a mixture of two or more backwashing media. Alternatively, one main rinsing step can take place by means of alternating (pulsating) rinsing with a first backwashing medium and a second backwashing medium that differs from the first backwashing medium. In this process and during the backwashing with a mixture, the duration of individual backwashing phases and relative quantities of the first and second backwashing media can be varied.

According to another further development, the first backwashing medium can be water and the second backwashing medium can be air.

As a result of the backwashing with air, an intensive movement of the filter materials and consequently optimal cleaning of the media filter are thereby achieved. By means of simultaneous backwashing with water and air, the dissolved, deposited dirt, i.e., the separated particles or macromolecules, are carried out of the filter.

According to a further development, the backwashing can additionally comprise the cleaning steps: abating the level of a backwashing medium above the filter layer of the media filter, filling the media filter with the untreated fluid after the completion of the pre-rinsing step and the main rinsing steps and start-up of the media filter including discarding the filtrate.

Abating the level of a backwashing medium after a backwashing step generally prevents a filter material discharge in the subsequent backwashing step. Starting up the media filter can take place particularly at the end of the cleaning process before resuming the filtration operation. In this process, the untreated fluid is fed through the media filter as in the filtration process, but the filtrate is discarded or fed back to the untreated fluid.

According to a further development, the starting of a cleaning process of the filter and/or the continuation of a filtering process can take place on the basis of the output value. Particularly the step of starting the cleaning process can thereby comprise a selection of the type of cleaning process from the following group: backwashing of the filter, cleaning-in-place of the filter, backwashing and cleaning-in-place of the filter, general cleaning of the filter and predetermined cleaning programs.

According to another further development, the continuation of a cleaning process of the filter and/or the termination of a cleaning process of the filter and the resumption of the filtration operation after the termination of the cleaning process can take place on the basis of the output value.

The method according to the disclosure can furthermore comprise the assessment of a cleaning success of at least one cleaning step of the cleaning process on the basis of the fuzzy logic and/or of artificial neural networks.

The assessment of a cleaning success or cleaning failure can thereby take place according to the above-described rules of the fuzzy theory by means of the formulation of suitable linguistic rules.

Criteria (linguistic rules) for the assessment of the cleaning success in a media filter are, for example, the following:
Length of the first filtrate directly after the cleaning. Filtration is in the operation direction “to the drain” (i.e., the first filtrate is discarded), because directly after the cleaning there can still be residual, previously filtered-off substances in the first filtrate that are dissolved by the cleaning but that are still in the media bed, and consequently that are flushed out in the first filtrate. The discarding of the filtrate takes place, e.g., until such a time as the turbidity of the filtrate reaches or falls below a preset level.
How quickly the turbidity falls below or reaches a preset level.
The extent to which the differential pressure between the filtrate and the non-filtrate during the start-up of the filter lies in the range of a freshly filled (unloaded/unused) filter.
Length of the filtration running time until the next required cleaning.
The bed expansion, whereby here the water temperature must be taken into consideration because it influences the expansion. Example: At 35° C., the filter bed is lifted minimally—the water has a lower viscosity at this temperature (viscosity decreases as the temperature increases). At, e.g., 8° C. there is therefore more lifting.

Whether rinsing with water and/or air was carried out can also be taken into account when assessing the cleaning success. The special sequence of cleaning steps with water or air can likewise influence the cleaning success.

By assessing the cleaning success, it is possible to achieve an optimization of the process parameters during the cleaning process and also during the filtration by means of feedback. In particular, the cleaning process can be optimized continuously by means of periodic assessment of the cleaning success.

The assessment of the cleaning success can thereby particularly take place on the basis of the same process variables that were used partially or completely to determine the output value or those output values, whereby the starting of the cleaning process took place depending on this output value or these output values. In particular, the assessment of the cleaning success can take place in accordance with the same method according to which the starting of the cleaning process has taken place. In particular, one or more linguistic terms of the precondition and/or of the action of one or more rules can thereby be negated. In this case, it is possible to achieve an especially simple formulation of the required linguistic rules.

According to a further development, the assessment of the cleaning success can be carried out by the same fuzzy controller and/or artificial neural network that take over the open-loop control and/or closed-loop control of the start of the cleaning process. Alternatively to this, the assessment can be carried out by a separate fuzzy controller and/or artificial neural network.

The assessment of a cleaning success of a cleaning process of the filter can take place on the basis of one or more output values that have been determined according to the method described above with the help of the fuzzy logic and/or artificial neural networks. In particular, the assessment of the cleaning success of a cleaning process of the filter can take place on the basis of the backwashing resistance of the filter and/or its temporal change.

According to another further development, the duration and/or intensity of the at least one cleaning step can be open-loop controlled or closed-loop controlled on the basis of the assessment of the cleaning success. In particular, the duration and/or intensity of the at least one cleaning step can be adjusted on the basis of the assessment of the cleaning success of a preceding cleaning. The preceding cleaning can likewise be a backwashing step, or it can be another cleaning process of the filter, particularly a cleaning process from the group described above.

The intensity of the at least one backwashing step can thereby be adjusted by the adjustment of at least one parameter from the following group of backwashing parameters: volume flow of a backwashing medium, flow rate of the backwashing medium in a backwashing inlet, pressure of the backwashing medium in the backwashing inlet, and temperature of the backwashing medium in the backwashing inlet, as well as their temporal changes.

The open-loop control and/or closed-loop control of the duration and/or intensity of the at least one cleaning step can take place according to the method described above in accordance with the fuzzy logic by means of a fuzzy controller.

In a further development, the open-loop control and/or closed-loop control can take place by means of a neuro-fuzzy controller, whereby the open-loop control and/or closed-loop control comprises the following steps: logging of cleaning successes and cleaning failures, assessment of the logged cleaning successes and cleaning failures by an artificial neural network, and adjustment of at least one process parameter of at least one cleaning step on the basis of the assessment by the artificial neural network.

Cleaning successes and cleaning failures of individual cleaning steps or also of the entire cleaning process can thereby be assessed and logged.

By using an artificial neural network, the open-loop control and/or closed-loop control of the cleaning process can be trimmed towards an optimized expert system which optimizes the process of the backwashing with regard to duration and intensity even without previous and external expert knowledge.

An artificial neural network consists of one or more artificial neurons which are arranged in one or more layers. Each artificial neuron thereby determines an output signal from one of more input signals. A net input as the sum of the weighted input signals can thereby be determined from the one or more input signals with the aid of one or more predetermined weights. The output signal can be determined from the net input by using an activation function. The activation function can thereby be a threshold function, a sigmoid function or a linear function. A sigmoid function thereby has the advantage that it is continuously differentiable and consequently can be used in the optimization method like the method of the steepest gradients. An artificial neuron can particularly be present in the form of a perceptron with a variable threshold.

An artificial neural network particularly has the advantage that it is a learning system. The learning of an artificial neural network thereby takes place generally by adjusting the weights of the input signals of the neurons. In particular, a learning step can comprise the application of one or more predetermined input signals and the comparison of one or more output signals of the neuron or neurons with one or more desired values. In the next learning step, the weights of the neurons can thereby be changed such that there is a reduction in the deviation of the output signal or output signals from the desired value or values, and consequently in the error or errors.

Open-loop control and/or closed-loop control of a filter system on the basis of an artificial neural network can consequently be adjusted flexibly to changing process conditions.

For a multi-layer neural network, such as the multilayer perceptron (MLP), the backpropagation algorithm can be used for carrying out a learning step. The backpropagation algorithm can thereby determine the minimum of an error function of a particular learning problem by a descent in the gradient direction along the error function.

In the case of a multi-layer neural network, generally each neuron of a layer is connected to the outputs of all neurons of the preceding layer. The neurons of the first layer (input layer) are connected to the predetermined input signals.

An artificial neural network for the open-loop control and/or closed-loop control of a filter system, particularly of a filter cleaning process, can be trained offline, i.e., without process control, by an expert, or (also) online, i.e., during an ongoing process control.

In particular, an artificial neural network in the form of a neuro-fuzzy controller can be combined with a fuzzy controller according to the method according to the disclosure. In this way, the transparency of the intuitive rules of fuzzy systems can be combined with the learning capability of artificial neural networks. In particular, a neuro-fuzzy controller is capable of learning linguistic rules and/or membership functions and of optimising existing ones.

A neuro-fuzzy controller can thereby be implemented as a cooperative system in which the neural network works independently of the fuzzy system and the parameters of the fuzzy system are determined and/or optimized by the neural network. The neural network can thereby learn by learning fuzzy sets or by learning linguistic rules. The learning of fuzzy sets can take place by means of a modified backpropagation method in which the position and form of the membership function of the fuzzy set are changed instead of the weight. When applying a gradient method to the optimization, it is thereby advantageous to use differentiable membership functions, such as the Gaussian bell curve. Additionally, the inference can be done by means of forming the product instead of forming the minimum of the membership function of the premises. The learning of rules can take place by means of training the neural network by means of the capture of regularities in the process control and the assessment of the same according to stipulated criteria. In particular, this can take place during the operation of a filter system by an expert. After the conclusion of this offline learning process, the found regularities can be expressed in rules with the help of stipulated fuzzy sets, i.e., linguistic terms. Alternatively or additionally, an online neuro-fuzzy system can be equipped at the beginning with a rule base in which the roughly developed fuzzy sets are linked to one another. The learning process by means of observing and assessing the process control can thereby affect the fuzzy sets or the rules.

A neuro-fuzzy controller can, however, also be implemented as a hybrid system in which the properties of the fuzzy logic and those of the artificial neural network are combined inseparably. In a fuzzy neuron, the fuzzy sets can replace the weights, whereby in the fuzzy neurons of an inner layer the determination of the grades of membership (fuzzification) for the input signals and their inference replace the weighted sum and the activation function. In the fuzzy neurons of the output layer, on the other hand, the composition and defuzzification can replace the weighted sum and the activation function. The error function at the system output can thereby likewise be depicted as a fuzzy set. One possibility for learning in the hybrid neuro-fuzzy controller consists of stipulating all the possible rules for the open-loop control and/or closed-loop control of the filter system or of a sub-process before commissioning the controller and having unnecessary rules eliminated by the neuro-fuzzy controller during online operation.

Correspondingly, in a further development, the method for the open-loop control and/or closed-loop control by means of a neuro-fuzzy controller can comprise the elimination or prioritization of at least one cleaning step. Predetermined safety mechanisms can thereby prevent the occurrence of a complete elimination of a cleaning process of the filter. The tendency of a neuro-fuzzy controller toward complete elimination of a cleaning process of the filter can be used for the assessment of the quality of the cleaning process.

The open-loop control and/or closed-loop control of the filter system, and likewise the open-loop control and/or closed-loop control of a filter cleaning process, can be carried out by one or more fuzzy controllers and/or artificial neural networks. The controllers can thereby be connected in parallel, meaning independently of one another, or at least partially in series, meaning each is an extension of a previous one. One or more fuzzy controllers can thereby be prioritized.

An adjustment of the parameters described above, e.g., of the parameters adjusted in an optimization step, can additionally or alternatively also be carried out independently of the open-loop control and/or closed-loop control according to the disclosure, particularly by an external system, such as, e.g., a programmable system and/or by an expert.

If needed, the set of the process variables to be captured and/or of the parameters to be controlled can also be divided into sub-groups, whereby the open-loop control and/or closed-loop control of the variables or parameters of the sub-group can be carried out by a fuzzy system and/or artificial neural network, and also by methods for the control and/or optimization according to the state of the art. The latter methods particularly include the classic control with PID controllers or expert algorithms, as well as optimization methods based on probabilistic methods, genetic algorithms, or Turing machines. By dividing up the parameter space, it is possible to reduce particularly the need for computing power and memory as well as the number of required linguistic rules and/or training examples.

In a further development, the rough open-loop control and/or closed-loop control can furthermore be carried out by a classic method or a fuzzy controller, while the fine tuning of the parameters to be optimized can take place by means of an artificial neural network or a neuro-fuzzy controller.

According to a further development, an optimization of the cleaning process can take place by means of minimizing a cost function of the cleaning process, whereby the cost function comprises the assessment of at least one cost factor from the following group of cost factors: duration of the cleaning process, quantity of the first backwashing medium required for the cleaning process, quantity of the second backwashing medium required for the cleaning process, energy required for the cleaning process, filter material discharge caused by the cleaning process, quantity of filtrate discarded during the start-up filtering, service life of the filter.

According to another further development, the assessment of the at least one cost factor can be made on the basis of the fuzzy logic and/or artificial neural networks. The cost function of the cleaning process can particularly be equated to the above-described error function of an artificial neural network if the output signals of the artificial neural network indicate the deviation of at least one cost factor from the above group from the predetermined target value. In this case, the learning process of the artificial neural network already contributes to the optimization of the cost function.

In the formation of a cost function from more than one cost factor, the influencing cost factors can be weighted with respect to one another. The minimization of the cost function can particularly take place according to one of the gradient methods known in the state of the art, particularly according to the conjugate gradient method or the steepest gradient method. In the case of minimization according to one of the gradient methods, it is advantageous to use differentiable membership functions for the influencing linguistic terms. Moreover, boundary conditions for the parameters that are to be optimized can likewise be depicted by fuzzy sets.

In an additional further development, one or more fuzzy controllers and/or artificial neural networks are integrated directly into a programmable logic controller (PLC).

The method according to the disclosure, particularly in its further development on the basis of neuro-fuzzy controllers, allows intelligent open-loop control and/or closed-loop control of a filter system for the filtration of an untreated fluid with a media filter which is detached from a rigid sequencing according to defined switch points at fixed values of pumps and regulating valves and fixed limiting values and fixed time increments which, as switching criteria, trigger the next step. Moreover, the method according to the disclosure allows an optimization of the operation of a filter system with respect to the duration and efficiency of the filtration and filter-cleaning processes, as well as with respect to the use of resources, such as, e.g., filter materials, cleaning materials and energy.

Due to the use of the fuzzy logic, it is furthermore no longer obligatory to integrate the process knowledge on the basis of complicated mathematical models (such as, for example, Marquardt modelling), meaning by means of expert knowledge, into the running and control of the process flow. It is rather the case that by means of simple, verbal if-then relationships, using the linguistic rules described above the open-loop control and closed-loop control of the process flow of a filter system can be influenced or even completely taken over by the ordinary system operator. In particular, this allows the simplified adjustment of the open-loop control and/or closed-loop control of a filter system to changed process conditions.

According to the disclosure, the use of an artificial neural network can take place without deeper knowledge of the process, whereby the system's learning capability replaces a lack of expert knowledge. On the other hand, if a fuzzy controller is used, familiar process knowledge can be used and realised by means of simple interpretation and implementation. The combination of the fuzzy logic and artificial neural networks makes it possible to use the advantages of the particular system optimally, while the disadvantages of the other particular system can be balanced out or at least moderated.

In the above-described examples for the method according to the disclosure, the open-loop control and/or closed-loop control of a filter process can comprise the adjustment of at least one process parameter for the filter process. The adjustment of the at least one process parameter can thereby take place according to the fuzzy logic and/or by means of an artificial neural network. In particular, the rules for the adjustment of the at least one process parameter can be formulated according to the fuzzy theory by means of predetermined linguistic terms.

The at least one process parameter can hereby be selected from the following group: temperature of the fluid in a filter inlet, pressure of the fluid in the filter inlet, differential pressure of the fluid between the filter inlet and a filter outlet, differential pressure between the fluid in the filter inlet and a filtrate, volume flow of the fluid fed in the filter inlet, flow rate of the fluid fed in the filter inlet.

### BRIEF DESCRIPTION OF THE DRAWINGS

Further characteristics and explanatory embodiments as well as advantages of the present disclosure are explained in more detail in the following on the basis of the drawings. It shall be understood that the embodiments do not exhaust the range of the present disclosure. It shall furthermore be understood that some or all of the features described in the following can also be combined with one another in other ways.

FIG. 1 depicts a schematic diagram for a closed-loop control cycle for a filter system with three fuzzy controllers, which themselves open-loop control and/or closed-loop control the filtration sequence, the time point for a cleaning and the cleaning sequence.

FIG. 2 depicts the logical combination of two linguistic terms according to a predetermined rule, taking the ‘clean’ correcting variable as an example.

FIG. 3 depicts the composition of two predetermined rules for the determination of a correcting variable, taking the ‘backwash only’ correcting variable as an example.

FIG. 4 depicts the prioritization of a rule, taking the ‘continue filtration’ correcting variable as an example.

FIG. 5 shows the assessment of the cleaning success on the basis of the fuzzy logic, taking the ‘restart filtration’ correcting variable as an example.

FIG. 6 shows the optimization of the cleaning sequence on the basis of the fuzzy logic.

FIG. 7 shows an assessment log for cleaning successes and cleaning failures, which functions as the basis for the control of the cleaning sequence by means of an artificial neural network.

### DETAILED DESCRIPTION OF THE PREFERRED EMBODIMENT

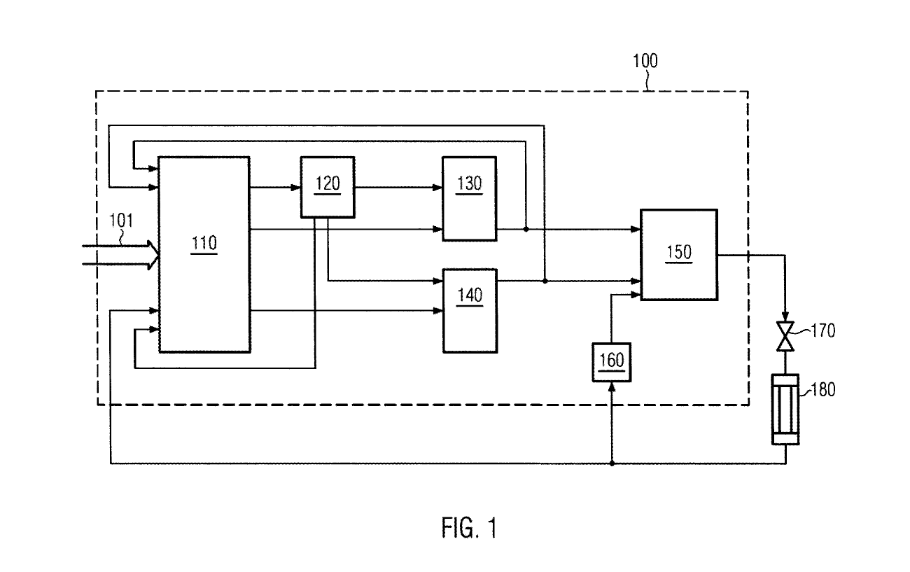

FIG. 1 illustrates an embodiment of the present disclosure by way of example. It depicts a closed-loop control cycle 100 for a filter system with three fuzzy controllers. A number of process variables 101 are captured and, if necessary, stored in a first capture unit 110. The capture unit 110 is used in this exemplary design in addition to the assessment of the success of filter cleaning processes, particularly the cleaning steps of backwashing processes, on the basis of the process variables captured in the area of the media filter 180, such as, e.g., the temporal change in the backwashing resistance.

The data captured by the capture unit 110 can additionally be scaled and/or further processed in a scaling unit 120. During the processing, expert knowledge of the filtering process in particular can influence the filtering process.

The captured and possibly further processed data can, for example, be transmitted to two independent (neuro-)fuzzy controllers according to the present disclosure, whereby a first fuzzy controller 130 observes the deviation of the current filtration from a reference curve which was, for example, recorded during the commissioning of the filter system. Together with the implemented linguistic rules, the filtration sequence is controlled optimally and, if necessary, the discontinuation of filtration is defined.

A second fuzzy controller 140 determines, on the basis of implemented linguistic rules, the necessity of the initiation of a cleaning process of the filter, such as a backwashing or a cleaning-in-place, as well as the optimal time point for the initiation of the cleaning process.

In the exemplary embodiment shown in FIG. 1, the closed-loop control cycle comprises a third fuzzy controller 150, which itself controls and optimizes a filter cleaning process. For this purpose, the third fuzzy controller 150 receives output data of the two fuzzy controllers 130 and 140 which, e.g., quantize a deviation from a reference curve and the necessity of a filter cleaning process, and initiates and controls the cleaning process on the basis of the received data. In particular, the fuzzy controller 150 can be a neuro-fuzzy controller which is able to eliminate completely unfavorable cleaning steps from a cleaning program and prioritise and/or add to the cleaning program other effective and time-sparing steps. The controller 150 can additionally select the type of cleaning process and/or a suitable cleaning program. The controller 150 controls as needed a valve 170, with the help of which the media filter 180 is cleaned, e.g., by backwashing. Through a second data capture unit 160, the controller 150 receives feedback on the progress of the cleaning process via process data, which are measured in the area of the filter 180. Particularly included here can be a measurement of the backwashing resistance of the filter, whereby the second data capture unit determines and checks the temporal change in the backwashing resistance and, in the case of the desired development of the backwashing resistance, sends a signal for the next cleaning step to the fuzzy controller 150. The data measured in the area of the filter can likewise be fed to the first data capture unit 110, in order to be further processed from there.

Due to the division of the fuzzy control into three independent fuzzy controllers with the tasks: a) the control of the filter with the objective of a long service life with optimized flow, optimal filtration end time with the start point of a cleaning, b) the control of the cleaning for setting an optimal cleaning end by means of observation of the current cleaning, and c) the optimization of the cleaning by means of the selection of an optimized cleaning type and optimized cleaning steps and their number based on the learning from preceding cleaning steps, it is possible to prevent the fuzzy control from being overloaded due to too many linguistic rules and terms and the necessity of an overly complex artificial neural network.

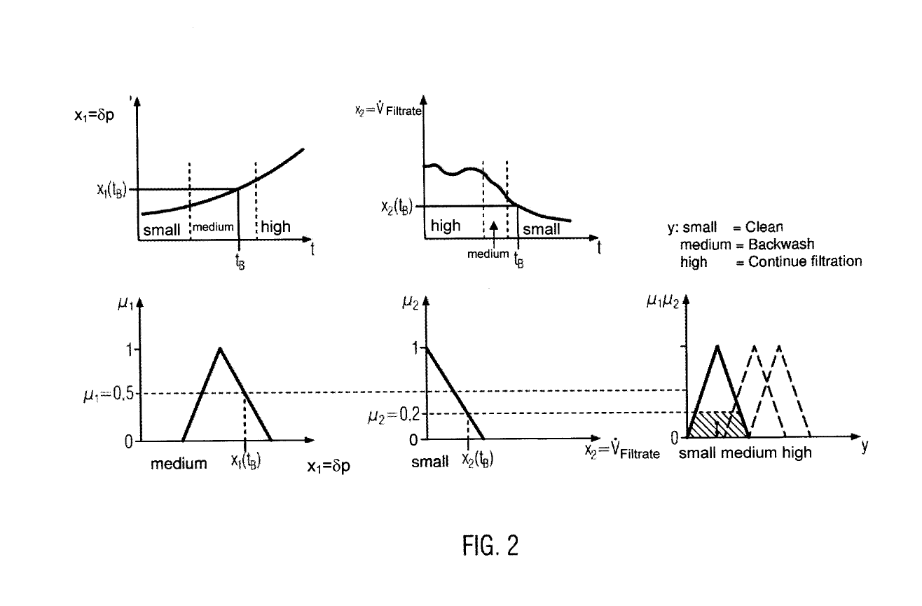

FIG. 2 shows by way of example the logical combination of two linguistic terms according to a predetermined rule, taking the ‘clean’ correcting variable as an example. At a time t_{B}, the process variables x₁ (differential pressure between the untreated fluid in the filter inlet and the filtrate) and x₂ (volume flow of the filtrate) are measured. The dashed lines indicate the clear-cut division of the measurement curves into the areas of the linguistic terms ‘small’, ‘medium’ and ‘high’. The lower graphs depict membership functions for the linguistic terms ‘medium differential pressure’ and ‘small volume flow’, as well as for the linguistic term of the ‘clean’ action. The membership functions of the premises thereby depict the fuzzy sets corresponding to the upper sharp limits. The dashed lines in the lower graphs show the determination of the grades of membership of the measured data to the linguistic terms and the logical AND operation by the formation of the minimum. The resulting membership function of the ‘clean’ action of the predetermined rule is shown hatched. Further conceivable actions (‘backwash’, ‘continue filtration’), which can be determined by further linguistic rules (see discussion below) are shown with dashes.

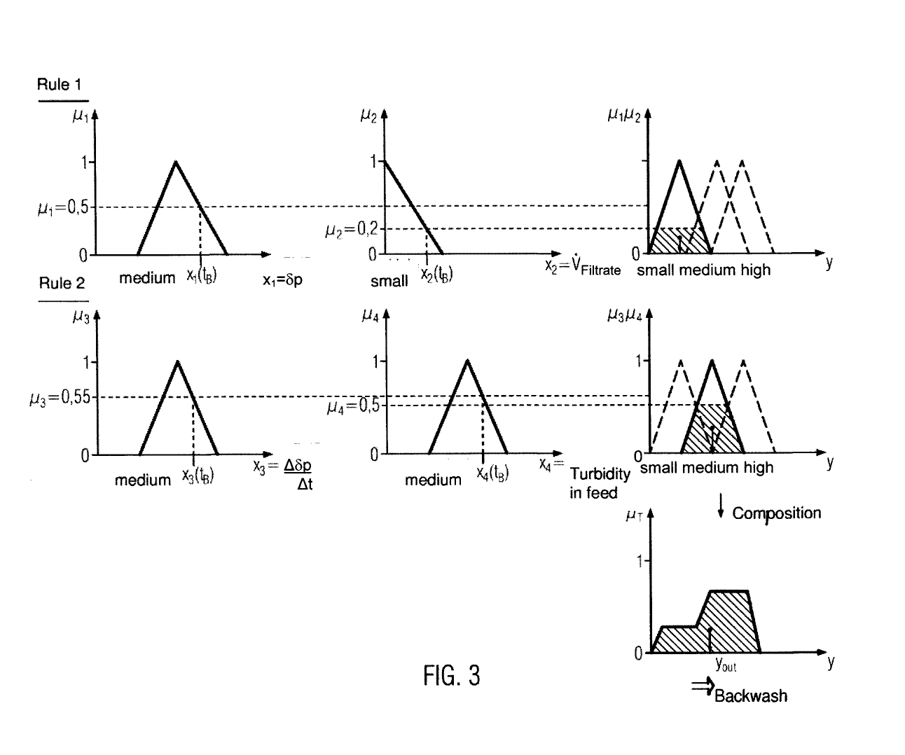

FIG. 3 depicts a combination of the first linguistic rule shown in FIG. 2 with a second linguistic rule by means of composition. The captured third and fourth process variables are thereby the temporal change in the differential pressure between the untreated fluid in the filter inlet and the filtrate x₃ and the turbidity of the untreated fluid in the filter inlet x₄. The second linguistic rule can consequently be formulated as follows: If temporal change in the differential pressure is medium and turbidity is medium, then backwash, which means output value y is medium. A rule for one of the alternative actions that were described above is consequently present with the second linguistic rule. Because the actions of the first and second linguistic rules extend to the same output value, a composition of the two rules according to the laws of the fuzzy logic, here by the combination of the two membership functions into one overall membership function, can take place. In the depicted exemplary design, the value of the output value is determined by the formation of the center of gravity of the area lying under the overall membership function.

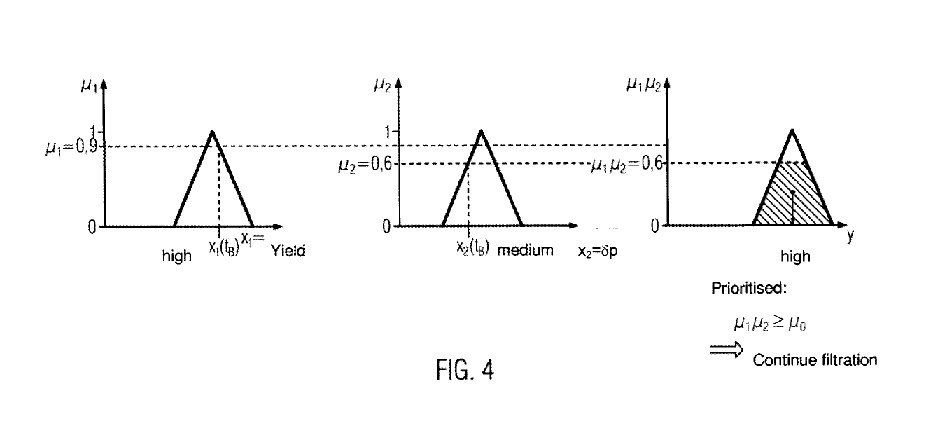

FIG. 4 depicts the prioritization of a rule, taking as an example a third linguistic rule with the ‘continue filtration’ action, which is the third of the alternative actions given above. The captured process variables here are the yield x₁ and the differential pressure between the untreated fluid in the filter inlet and the filtrate x₂, whereby the third linguistic rule is as follows: If yield is high and differential pressure is medium, then continue filtration, meaning output value y is high. Because the rule is prioritized, e.g., by setting corresponding weightings by means of an artificial neural network, no composition of the resulting membership function with one of the resulting membership functions of one of the two other rules takes place. Instead, in this design, for example, the grade of membership of the action is compared to a threshold value in order to set the corresponding correcting variable. The shown example demonstrates how a prioritized rule dominates the open-loop control or closed-loop control process.

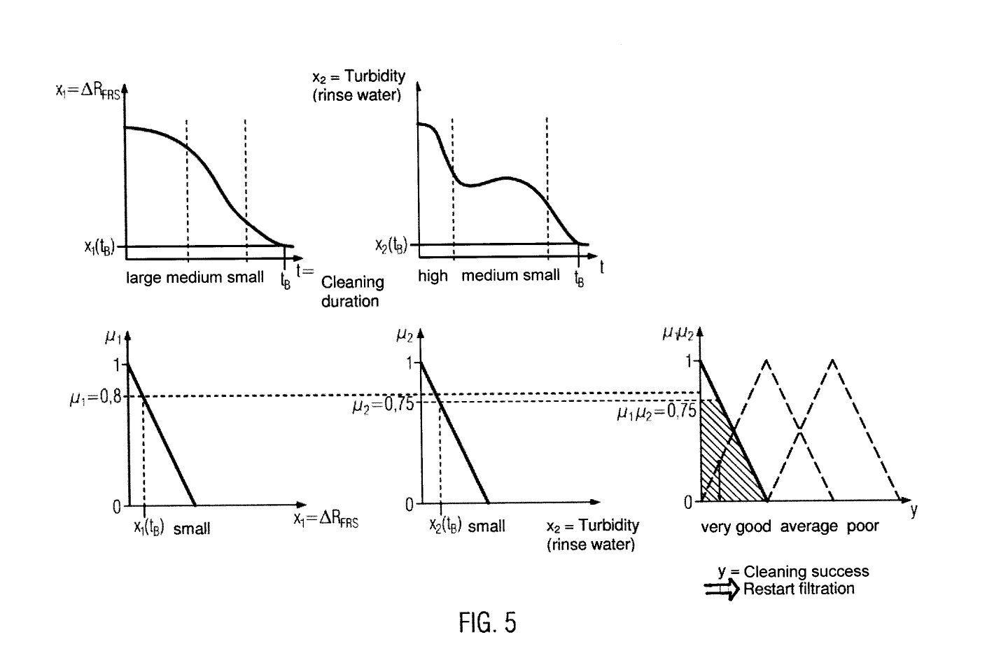

FIG. 5 shows by way of example the assessment of a cleaning success with the help of a fuzzy controller. For this purpose, in the upper row, first the temporal developments of the process variables: temporal change in the backwashing resistance of the filter x₁ and turbidity in the rinse water, meaning in the backwashing medium, in the backwashing outlet x₂ are shown, which are captured at the time t_{B}. The corresponding linguistic terms of the rule ‘If temporal change in backwashing resistance is small and turbidity in rinse water is small, then very good cleaning success’ are shown in the lower row. Because of the asymmetric form of the membership function of the ‘very good cleaning success’ action, then in this case it is also possible to use the center of gravity method for the determination of the output value. The figure shows how the same method of the fuzzy logic used previously for the open-loop control and/or closed-loop control can now also be used for the assessment of a cleaning success. Setting the corresponding ‘restart filtration’ correcting variable takes place here on the basis of the assessment of the cleaning success.

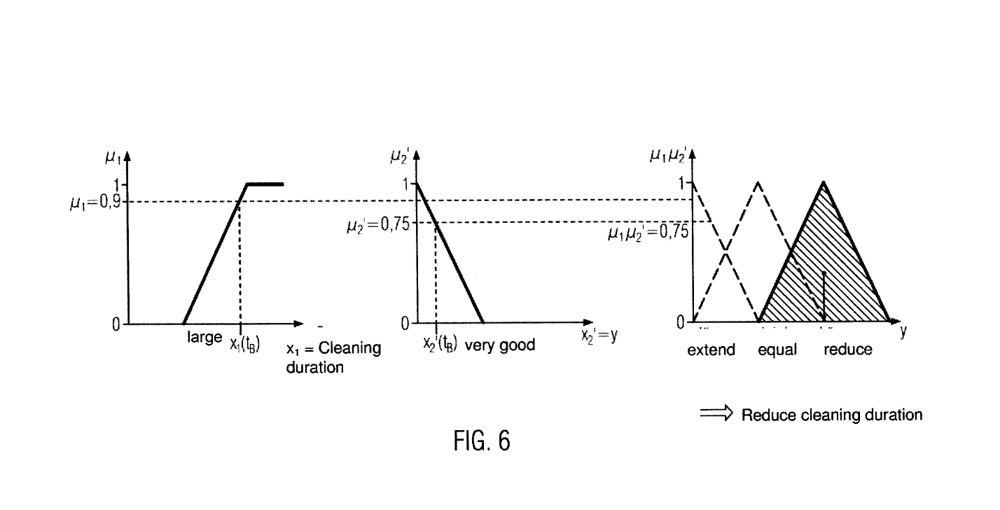

Finally, FIG. 6 shows how an interlinking results from the sequencing of linguistic rules. The output quantity x₂=y of the linguistic rule of FIG. 5 is linked here to the process variable ‘cleaning duration’ x₁ according to the rule ‘If cleaning duration is long and cleaning success is very good, then reduce cleaning duration’. The rule demonstrates how by starting with the assessment of a cleaning success by means of a fuzzy controller, the cleaning duration can be optimized on the basis of the fuzzy logic. FIG. 6 consequently shows an optimization step by means of purely a fuzzy controller. Alternatively or additionally to this, the optimization step and/or the assessment step can be carried out by an artificial neural network.

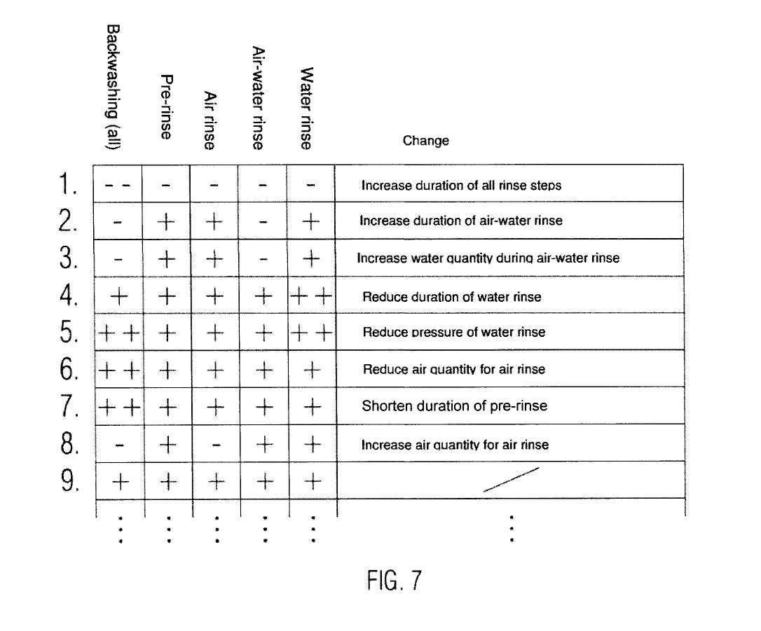

An assessment table for the cleaning successes of the cleaning steps: pre-rinse, air rinse, air-water rinse, water rinse and the entire backwashing process is shown in FIG. 7. Based on the assessment table, it is possible to make a proposal for a change in the process parameters for the purpose of optimization. The proposal can take place with the help of an artificial neural network, a fuzzy controller, or a neuro-fuzzy controller.

Plus signs indicate a success and minus signs a failure of the action, while a doubled plus sign indicates a repeated or especially good success. In the event of repeated success of the water rinse (see step 5), e.g., the action ‘reduce pressure of water rinse’ is hereby triggered. The step size of the adjustment steps, e.g., the extension of the rinsing duration, can thereby be predetermined or can itself be adjusted by means of a (neuro-)fuzzy controller. The control can hereby be carried out as described above by means of a fuzzy controller, a neuro-fuzzy controller or an artificial neural network.

The figures described above show how simple, intuitive rules building on the principles of the fuzzy logic make possible reproducible and optimized process control without special expert knowledge. The automatic optimization of the process by means of fuzzy controllers and/or artificial neural networks thereby takes over the role customarily allocated to the expert.

1. A method for the open-loop control and/or closed-loop control of a filter system for the filtration of an untreated fluid with a media filter, comprising the open-loop control and/or closed-loop control takes place on the basis of a fuzzy logic and/or artificial neural networks.

2. The method according to claim 1, and comprising:
capturing at least a first and a second process variable of the filter system;
determining a first grade of membership of the first process variable to a first linguistic term on the basis of a first predetermined membership function;
determining a second grade of membership of the second process variable to a second linguistic term on the basis of a second predetermined membership function;
logically combining the first and second linguistic terms according to at least a first predetermined rule for the determination of a first resulting membership function of the action of the first predetermined rule;
determining an overall membership function on the basis of the first resulting membership function of the action of the at least first predetermined rule;
obtaining an output value from the overall membership function; and
open-loop control and/or closed-loop control of the filter system, depending on the output value.

3. The method according to claim 2, further comprising:
capturing at least a third and a fourth process variable of the filter system;
determining a third grade of membership of the third process variable to a third linguistic term on the basis of a third predetermined membership function;
determining a fourth grade of membership of the fourth process variable to a fourth linguistic term on the basis of a fourth predetermined membership function; and
logically combining the third and fourth linguistic terms according to at least a second predetermined rule for the determination of a second resulting membership function of the action of the at least second predetermined rule; wherein:
the overall membership function is determined by means of the composition of at least the first resulting membership function of the action of the at least first predetermined rule and the second resulting membership function of the action of the at least second predetermined rule.

4. The method according to claim 2, wherein the cleaning process comprises a backwashing, and wherein the backwashing comprises at least three cleaning steps, including at least one pre-rinsing step and at least a first and a second main rinsing step.

5. The method according to claim 4, wherein the rinsing during the first main rinsing step takes place with a first backwashing medium and the rinsing during the second main rinsing step takes place with a second backwashing medium that differs from the first backwashing medium.

6. The method according to claim 5, wherein the first backwashing medium is water and the second backwashing medium is air.

7. The method according to claim 4, wherein the backwashing further comprises:
abating the level of a backwashing medium above the filter layer of the media filter;
filling the media filter with the untreated fluid after the completion of the pre-rinsing and main rinsing steps; and
start-up of the media filter including discarding the filtrate.

8. The method according to claim 2, wherein the continuation of the cleaning process of the filter and/or the termination of the cleaning process and the resumption of the filtration operation after the termination of the cleaning process take place on the basis of the output value.

9. The method according to claim 4, and further comprising:
assessment of a cleaning success of at least one cleaning step of the cleaning process on the basis of the fuzzy logic and/or artificial neural networks.

10. The method according to claim 9, wherein the assessment of the cleaning success takes place on the basis of the output value.

11. The method according to claim 9, wherein the duration and/or intensity of the at least one cleaning step is open-loop controlled or closed-loop controlled on the basis of the assessment of the cleaning success.

12. The method according to claim 11, wherein the open-loop control and/or closed-loop control is carried out by means of a neuro-fuzzy controller, and further comprises:
logging of cleaning successes and cleaning failures;
assessment of the logged cleaning successes and cleaning failures by means of an artificial neural network; and
adjustment of at least one process parameter of at least one cleaning step on the basis of the assessment by means of the artificial neural network.

13. The method according to claim 12, and further comprising the elimination or prioritization of at least one cleaning step.

14. The method according to claim 11, further comprising a minimization of a cost function of the cleaning process, wherein the cost function comprises the assessment of at least one cost factor from the following group of cost factors: duration of the cleaning process, quantity of the first backwashing medium required for the cleaning process, quantity of the second backwashing medium required for the cleaning process, energy required for the cleaning process, filter material discharge caused by the cleaning process, quantity of filtrate discarded during the start-up of the filter, service life of the filter.

15. The method according to claim 14, wherein the assessment of the at least one cost factor takes place on the basis of the fuzzy logic and/or artificial neural networks.

16. The method according to claim 1, wherein the open-loop control and/or closed-loop control of a filtering process comprises the adjustment of at least one process parameter for the filtering process.

17. The method according to claim 16, wherein the at least one process parameter is selected from the following group: temperature of the fluid in a filter inlet, pressure of the fluid in the filter inlet, differential pressure of the fluid between the filter inlet and a filter outlet, differential pressure between the fluid in the filter inlet and a filtrate, volume flow of the fluid fed in the filter inlet, flow rate of the fluid fed in the filter inlet.

18. The method according to claim 1, wherein the media filter is one of a gravel bed filter, a multilayer filter, and an activated charcoal filter.

19. The method according to claim 2, wherein the open-loop control and/or closed-loop control of the filter system is of one of a cleaning process of the media filter or a filtration process.
